(19) United States
(12) Patent Application Publication
(10) Pub. No.: US 2002/0135489 A1
(43) Pub. Date: Sep. 26, 2002

(54) Automatic diaper wetness warning device

(76) Inventors: Chin-Chen Chen, Pa Te City (TW); Hong-Lin Chen, Pa Te City (TW); Hong-Ming Chen, Pa Te City (TW); Yi-Ran Chen, Pa Te City (TW); Hong-Chih Chen, Pa Te City (TW)

Correspondence Address: JORDAN AND HAMBURG LLP, 122 EAST 42ND STREET, SUITE 4000, NEW YORK, NY, 10168, US

(21) Appl. No.: 10/061,720

(22) Filed: Feb. 1, 2002

Related U.S. Application Data
(63) Continuation-in-part of application No. 09/813,265, filed on Mar. 20, 2001, now abandoned.

(51) Int. Cl. G08B 21/00

(52) U.S. Cl. 340/604; 340/573.1

(57) ABSTRACT

An automatic diaper wetness warning device includes a diaper, a wetness signal transmitting device and an externally disposed signal receiver. The diaper is provided with a wetness signal transmitting device including a signal transmitting and a positive and negative pole sensing electric wire assembly. A suitable length of the inner end of the wire assembly is provided with an insulation coating material that can conduct electricity when wet, and is wound into a signal actuating section embedded in the diaper in a position that can readily absorb urine. When the insulation coating material of the signal actuating section is wet and becomes short circuit, the signal transmitter will automatically generate a signal, which is received by the signal receiver. The signal receiver sends a suitable warning to remind a person taking care of the user of the diaper to change diaper.

### CROSS-REFERENCES TO RELATED APPLICATIONS

This application is a continuation-in-part (CIP) application of Ser. No. 09/813,265 filed on Mar. 20. 2001.

### BACKGROUND OF THE INVENTION

The present invention relates to an automatic diaper wetness warning device, more particularly to an automatic warning device that, when a diaper is wet, sends a wanting to a person taking care of the user of the diaper to change the diaper.

Disposable diapers provide great convenience in looking after babies and adults with incontinence. Wet diapers are uncomfortable to the users and the urine may leak, which may mean more work to persons looking after the users.

Conventional diapers are not provided with any wetness warning device. Therefore, the diapers have to be checked from time to time, which may disturb the users, especially in cold weather.

Although there are diapers with wetness indicating means that change color when the diapers are wet, it is still necessary to pull down the user's pants to check the diapers. If the diapers are not checked in time, leakage may also occur.

### SUMMARY OF THE INVENTION

The primary object of the present invention is to provide an automatic diaper wetness warning device, in which a wetness signal transmitting device is disposed in a diaper in a suitable position such that when the diaper is wet, the wetness signal transmitting device will send a signal, which is received by a signal receiver disposed externally. The signal receiver also sends a warning signal to remind persons looking after users of the diapers to change the diaper.

Another object of the present invention is to provide an automatic diaper wetness warning device, in which the wetness signal transmitting device and the signal receiver are adjustable to be able to send or receive signals of different frequencies so that the warning device can be used for a number of users at the same time and can help persons looking after the users which particular user's diapers are wet.

### BRIEF DESCRIPTION OF THE DRAWINGS

The foregoing and other features and advantages of the present invention will be more clearly understood from the following detailed description and the accompanying drawings, in which,

FIG. 1 is an exploded perspective view of an automatic wetness warning device according to the present invention;

FIG. 2 is an assembled perspective view of the automatic wetness warning device according to the present invention;

FIG. 3 is a schematic view of the present invention, illustrating embedding of a signal actuating section;

FIG. 3A is a schematic enlarged view of the signal actuating section of FIG. 3; and

FIG. 4 is a schematic view of another embodiment of the signal actuating section.

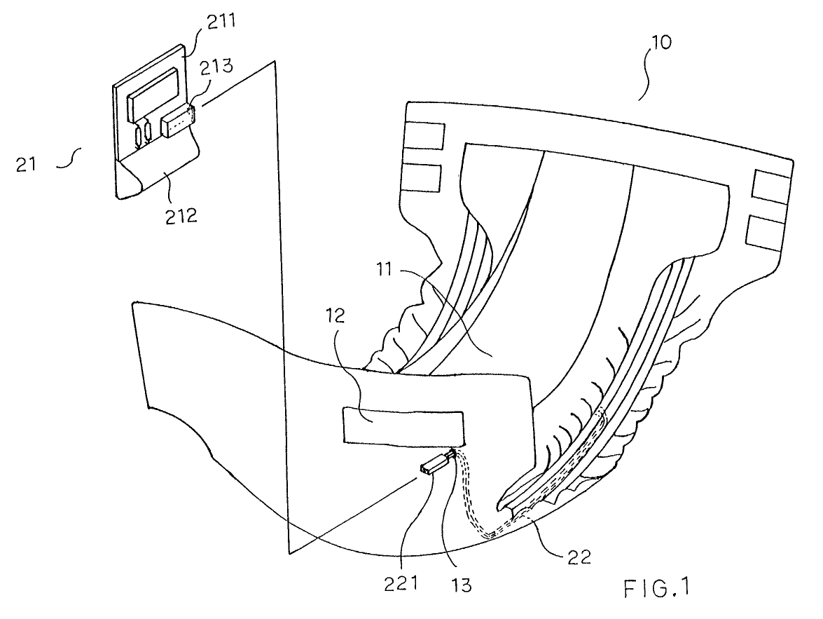

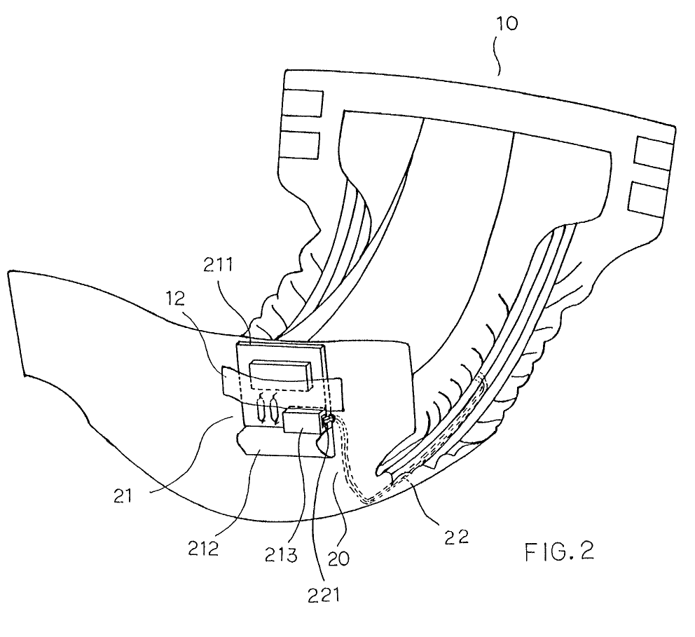

### DETAILED DESCRIPTION OF THE INVENTION

With reference to the drawings, an automatic diaper wetness warning device according to the present invention includes a diaper 10, a wetness signal transmitting device 20 and an externally disposed signal receiver 30.

The diaper 10 is a disposable diaper worn by a user to absorb the urine or feces.

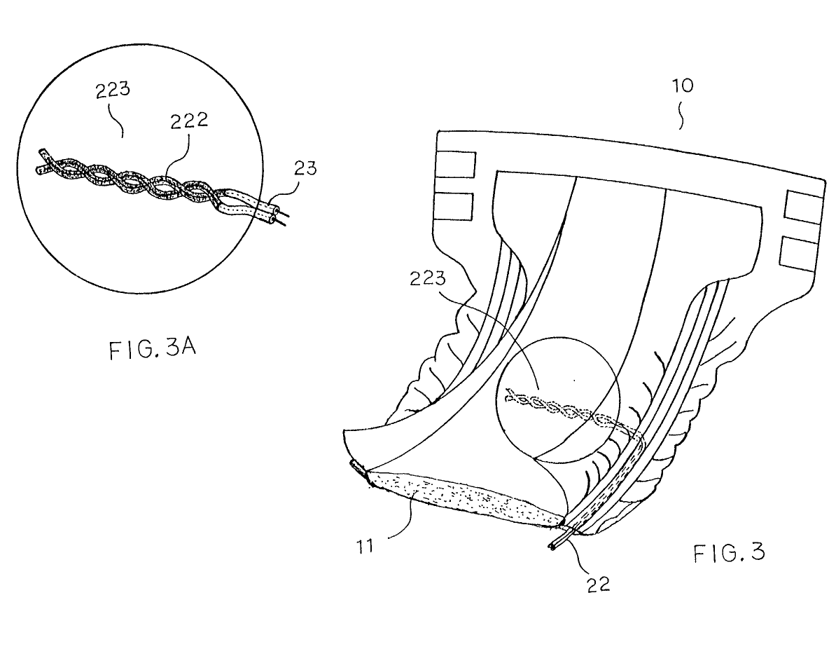

The wetness signal transmitting device 20 includes a signal transmitter 21 and a positive and negative pole sensing electric wire assembly 22. The signal transmitter 21 has a specially devices control circuit board 211. The control circuit board 211 is provided with a power source 212 formed by a battery and a socket 213 at suitable positions. The wire assembly 22 has an outer surface provided with an insulation material 23 and is disposed on the diaper 10 at a suitable position such that one end thereof extends through a hole 13 formed in the diaper 10 at a suitable position and is provided with a plug 221 corresponding to the socket 213 for connecting the wire assembly 22 and the signal transmitter 21. A suitable length of the other end of the wire assembly 22 is provided with an insulation coating material 222 that is electrically conductive when wet (such as a water absorbing paper), which is wound into a signal actuating section 223, as shown in FIG. 3 or FIG. 3A, and is embedded in the diaper 10 in a position that can absorb urine.

The signal receiver 30 can receive signals sent by the signal transmitter 21 and send a suitable warning signal (such as light, sound or a combination of both) to a person taking care of the user of the diaper. When the insulation coating material 222 provided on the signal actuating section 223 is wet by urine and becomes short-circuited, the signal transmitter 21 of the wetness signal transmitting device 20 will automatically send a suitable signal, which is received by the signal receiver 30 disposed externally. The signal receiver 30 then sends a warning signal to remind the person taking care of the user to change the diaper.

The diaper 10 is optionally provided with a self-adhesive tape 12 at a position corresponding to the plug 221 for securing the signal transmitter of the wetness signal transmitting device 20. Since the wetness signal transmitting device 20 utilizes the socket 213 thereof to couple with the plug 221 of the wire assembly 22, once the diaper 10 is wet and has to be disposed, the signal transmitter 21 can be removed and inserted into a new diaper with the wire assembly 22. In addition, since the signal transmitter 21 is very small, it will not cause any discomfort to the user, and is easy to operate.

To prevent consumption of electric energy of the power source 212 after short-circuit of the signal actuating section 223. the power source 212 of the wetness signal transmitting device 20 can be cut off in a suitable period of time after short-circuit of the signal transmitting section 223. When the signal transmitter 21 is changed to a new diaper, the circuit of the power source 212 will be automatically opened to supply the necessary power.

In addition, in order for the present invention to be adapted for use in nurseries or homes for the aged where users of diapers are many, the signal transmitter 21 and the signal receiver 30 can be adjusted to be able to send or receive signals of varying frequencies so as to warn persons taking care of particular users when their diapers are wet, without disturbing other users. Thus, the work of checking the diapers can be made easier.

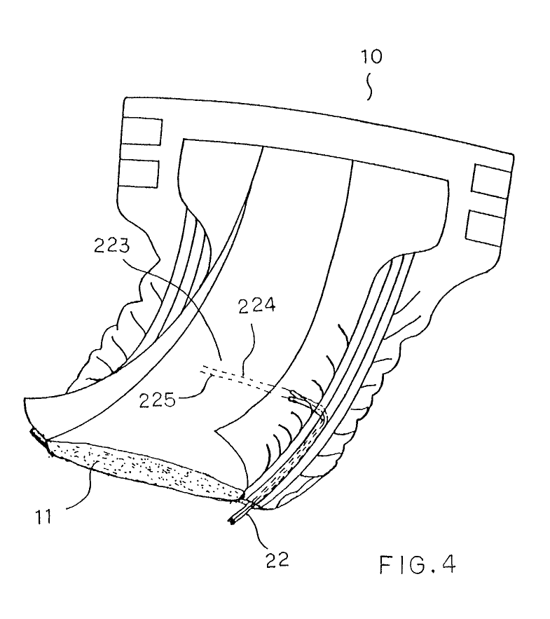

Optionally, the signal actuating section 223 dose not include the insulation coating material 222. In other words, wires 224 and 225 can be spacedly embedded in the water absorbing layer 11 of the diaper 10, as shown in FIG. 4. When the water absorbing layer 11 is wet, the wires 224, 225 will, due to conductive capability of the urine, activate the signal transmitter 21 at the other end thereof to warn wetness of the diaper.

Of course, like a printed-circuit, the said wire assembly 22 can also be formed on one suitable soft strip or two different suitable soft strips. Additionally, for letting said printed-circuit type wire assembly 22 be connected with said signal transmitter 21 directly, we delete said socket 213 and plug 223, and let said printed-circuit type wire assembly be connected to a signal receiving end of said control circuit board 211 directly.

Further, for promoting the efficiency of conduction, there will be a conducting layer disposed in a portion of said diaper. The said conducting layer has a set of first conducting wires and a set of second conducting wires formed on a suitable soft layer. Because said printed-circuit type wire assembly was connected to said set of first conducting wires and said set of second conducting wires separately, so, it can promote the efficiency of conduction.

In summary, since the automatic diaper wetness warning device of the present invention gives an indication of diaper wetness to the person taking care of the user of the diaper, changing of the diaper can be done without taking the trouble to check the diaper, which may disturb the user.

Although the present invention has been illustrated and described with reference to an embodiment thereof it should be understood that it is in no way limited to the details of such embodiment but is capable of numerous modifications within the scope of the invention.

What is claimed is:

1. An automatic diaper wetness warning device comprising: a diaper;
a wetness signal transmitting device including:
a signal transmitter having a control circuit board, said control circuit board including a power source and an electrical connector connected thereto;
a first electrical conductor connected to a positive pole of the electrical connector; and
a second electrical conductor connected to a negative pole of the electrical connector, said first and second electrical conductors each having a first end and a second end, said first ends of said first and second electrical conductors being provided with a connecting device for connecting with said electrical connector, said second end of each of said first and second electrical conductors being disposed in said diaper and having an insulation material on portions of second ends which conducts electricity between said first and second electrical conductors when said insulation material is wet such that said signal transmitter transmits a signal; and
a signal receiver for receiving signals transmitted by said transmitter and subsequently transmitting a warning signal;
wherein said power source of said signal transmitter cuts off within a period of time after completion of transmission of warning signals from said signal transmitter.

2. The automatic diaper wetness warning device of claim 1, further comprising a self-adhesive tape at the connecting device for securing said signal transmitter to said diaper.

3. The automatic diaper wetness warning device of claim 1, wherein said insulation material is a water absorbing paper.

4. The automatic diaper wetness warning device of claim 1, wherein said wetness signal transmitting device and said signal receiver are capable of transmitting at a first frequency and a second frequency, said second frequency being a different frequency from said first frequency.

5. The automatic diaper wetness warning device of claim 1, wherein said warning signal sent by said signal receiver is one of a warning light, a warning sound, and a combination of a warning light and a warning sound.

6. An automatic diaper wetness warning device comprising:
a diaper;
a wetness signal transmitting device including:
a signal transmitter having a control circuit board, said control circuit board including a power source and an electrical connector connected thereto;
a first electrical conductor connected to a positive pole of the electrical connector; and
a second electrical conductor connected to a negative pole of the electrical connector, said first and second electrical conductors each having a first end and a second end, said first ends of said first and second electrical conductors being provided with a connecting device for connecting with said electrical connector, said second end of each of said first and second electrical conductors being disposed in a portion of said diaper such that electricity is conducted between said first and second electrical conductors when said portion of said diaper is wet such that said signal transmitter transmits a signal; and
a signal receiver for receiving signals transmitted by said transmitter and subsequently transmitting a warning signal;
wherein said power source of said signal transmitter cuts off within a period of time after completion of transmission of warning signals from said signal. transmitter.

7. The automatic diaper wetness warning device of claim 6, further comprising a self-adhesive tape at the connecting device for securing said signal transmitter to said diaper.

8. The automatic diaper wetness warning device of claim 6, wherein said wetness signal transmitting device and said signal receiver are capable of transmitting at a first frequency and a second frequency, said second frequency being a different frequency from said first frequency.

9. The automatic diaper wetness warning device of claim 6, wherein said warning signal sent by said signal receiver is one of a warning light, a warning sound, and a combination of a warning light and a warning sound.

10. An automatic diaper wetness warning device comprising:
a diaper:
a wetness signal transmitting device including:
a signal transmitter having a control circuit board, said control circuit board including a power source and a signal receiving end thereto;
a first electrical conductor formed on a first suitable soft strip and having a first end and a second end; and
a second electrical conductor formed on a second suitable soft strip and having a first end and a second end, said first ends of said first and second electrical conductors being separately connected with a positive pole and a negative pole of the signal receiving end, said second end of each of said first and second electrical conductors being disposed in a portion of said diaper such that electricity is conducted between said first and second electrical conductors when said portion of said diaper is wet such that said signal transmitter transmits a signal; and
a signal receiver for receiving signals transmitted by said transmitter and subsequently transmitting a warning signal;
wherein said power source of said signal transmitter cuts off within a period of time after completion of transmission of warning signals from said signal transmitter.

11. The automatic diaper wetness warning device of claim 10, further comprising a self-adhesive tape at the connecting device for securing said signal transmitter to said diaper.

12. The automatic diaper wetness warning device of claim 10, wherein said wetness signal transmitting device and said signal receiver are capable of transmitting at a first frequency and a second frequency, said second frequency being a different frequency from said first frequency.

13. The automatic diaper wetness warning device of claim 10, wherein said warning signal sent by said signal receiver is one of a warning light, a warning sound, and a combination of a warning light and a warning sound.

14. The automatic diaper wetness warning device of claim 10, further comprising a conducting layer formed on a suitable soft layer and having a set of first conducting wires for connecting with the second end of said first electrical conductor and a set of second conducting wires for connecting with the second end of said second electrical conductor and being disposed in a portion of said diaper.

15. An automatic diaper wetness warning device comprising:
a diaper;
a wetness signal transmitting device including:
a signal transmitter having a control circuit board, said control circuit board including a power source and a signal receiving end thereto;
first electrical conductor and a second electrical conduct parallel formed on a suitable soft strip and each having a first end and a second end, said first ends of said first and second electrical conductors being separately connected with a positive pole and a negative pole of the signal receiving end, said second end of each of said first and second electrical conductors being disposed in a portion of said diaper such that electricity is conducted between said first and second electrical conductors when said portion of said diaper is wet such that said signal transmitter transmits a signal; and
a signal receiver for receiving signals transmitted by said transmitter and subsequently transmitting a warning signal;
wherein said power source of said signal transmitter cuts off within a period of time after completion of transmission of warning signals from said signal transmitter.

16. The automatic diaper wetness warning device of claim 15, further comprising a self-adhesive tape at the connecting device for securing said signal transmitter to said diaper.

17. The automatic diaper wetness warning device of claim 15, wherein said wetness signal transmitting device and said signal receiver are capable of transmitting at a first frequency and a second frequency, said second frequency being a different frequency from said first frequency.

18. The automatic diaper wetness warning device of claim 15, wherein said warning signal sent by said signal receiver is one of a warning light, a warning sound, and a combination of a warning light and a warning sound.

19. The automatic diaper wetness warning device of claim 15, further comprising a conducting layer formed on a suitable soft layer and having a set of first conducting wires for connecting with the second end of said first electrical conductor and a set of second conducting wires for connecting with the second end of said second electrical conductor and being disposed in a portion of said diaper.
